(19) United States
(12) Patent Application Publication
(10) Pub. No.: US 2016/0162510 A1
(43) Pub. Date: Jun. 9, 2016

(54) CLONE DATA MANAGEMENT

(71) Applicant: International Business Machines Corporation, Armonk, NY (US)

(72) Inventors: Dean Hildebrand, Bellingham, WA (US); John T. Olson, Tucson, AZ (US); Sandeep R. Patil, Pune (IN); Riyazahamad M. Shiraguppi, Pune (IN)

(21) Appl. No.: 14/558,760

(22) Filed: Dec. 3, 2014

(51) Int. Cl. G06F 17/30

(52) U.S. Cl. CPC G06F 17/30174; G06F 17/30138

(57) ABSTRACT

Embodiments of the present invention provide systems, methods, and computer program products for managing clone data to increase system performance and reduce disk space wastage by selectively pre-allocating and initializing clone data blocks based on a likelihood of subsequent write operations being performed on those clone data blocks.

### BACKGROUND OF THE INVENTION

The present invention relates generally to the field of data management systems, and more particularly creating and managing blocks of clone data.

In certain file systems, such as a General Parallel File System (GPFS™), clones of one or more files can be created. Clones are typically implemented by creating a read-only copy of data being cloned, and using a redirection mechanism to share disk space for the data that is common to the original file and the new clone. In this manner, clones can be used to make a copy of one or more files in a faster and more space efficient manner, since no additional disk space is consumed until the clone is modified. In one example, cloning can be used to create and deploy virtual operating system images for a plurality of users who can then customize the images based on personal requirements.

When a clone is subsequently modified, such as when one or more data blocks of the clone are written to, the file system allocates one or more new blocks of disk space, copies data from the corresponding one or more blocks of the original file into the newly allocated blocks, and modifies the data to reflect the changes made. Where the cloned files are of substantial size, such as where the cloned files are virtual operating system images, such allocation and initialization operations can result in significant performance overhead.

### SUMMARY

According to one aspect of the present invention, a method for managing clone data is provided, comprising: creating a clone child file from a clone parent file, wherein the clone child file comprises one or more blocks that correspond to one or more respective blocks of the clone parent file; selecting, by one or more computer processors, one or more blocks of the clone child file based, at least in part, on a likelihood of the selected one or more blocks of the clone child file being subsequently written to; allocating disk space for the selected one or more blocks of the clone child file; and copying, by one or more computer processors, data from one or more blocks of the parent file to which the selected one or more blocks of the clone child file correspond, to the allocated disk space for the selected one or more blocks of the clone child file.

### BRIEF DESCRIPTION OF THE DRAWINGS

FIG. 1 is a block diagram of a computing environment, in accordance with an embodiment of the present invention;

FIG. 2 is a flowchart illustrating operations for creating a clone parent file, in accordance with an embodiment of the present invention;

FIG. 3 is a flowchart illustrating operations for creating a clone child file, in accordance with an embodiment of the present invention;

FIG. 4 is a flowchart illustrating operations for pre-allocating and initializing clone child data, in accordance with an embodiment of the present invention;

FIG. 5 is a flowchart illustrating operations for calculating a pre-allocation order, in accordance with an embodiment of the present invention;

FIG. 6 is an example block access table, in accordance with an embodiment of the present invention;

FIG. 7 is an example clone relationship table, in accordance with an embodiment of the present invention;

FIG. 8 is an example pre-allocation order table, in accordance with an embodiment of the present invention; and

FIG. 9 is a block diagram of internal and external components of the computer system of FIG. 1, in accordance with an embodiment of the present invention.

### DETAILED DESCRIPTION

Embodiments of the present invention recognize that there can be substantial performance overhead associated with allocating and initializing blocks for clone files at the time at which those clone files are modified. Embodiments of the present invention also recognize that allocating and initializing all blocks for clone files at the time of creating the clone files can result in disk space wastage and latency. Embodiments of the provide systems, methods, and computer program products for managing clone data to increase system performance and reduce disk space wastage by selectively pre-allocating and initializing clone data blocks based on a likelihood of subsequent write operations being performed on those clone data blocks.

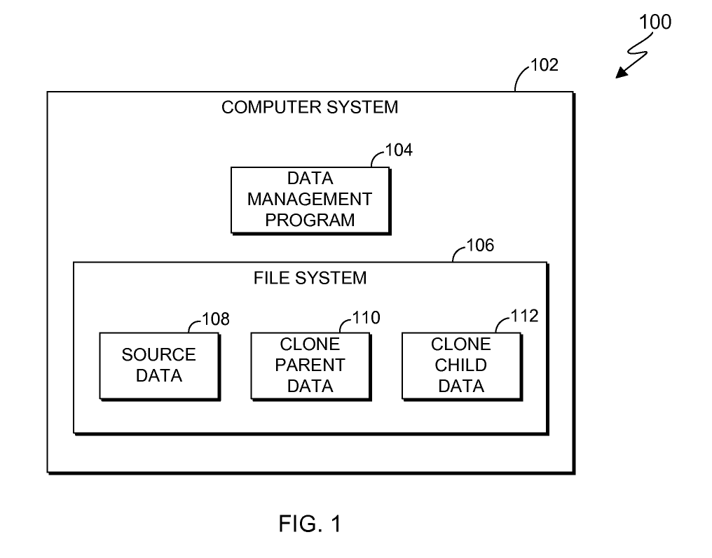

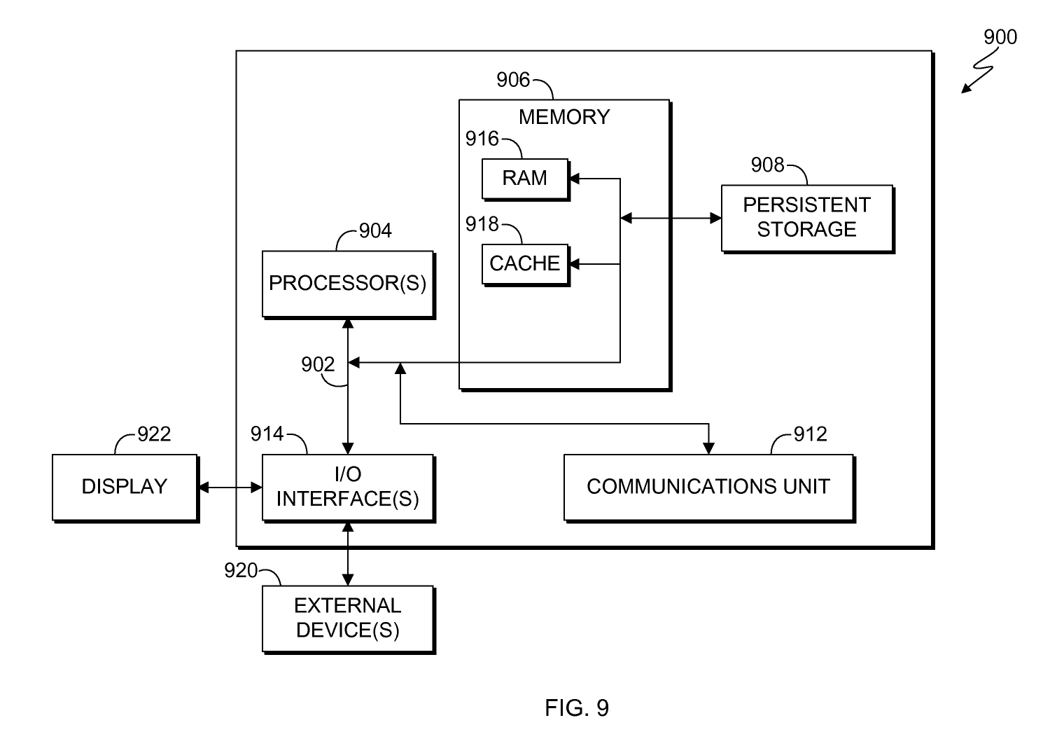

FIG. 1 is a functional block diagram of computing environment 100, in accordance with an embodiment of the present invention. Computing environment 100 includes computer system 102. Computer system 102 can be a desktop computer, laptop computer, specialized computer server, or any other computer system known in the art. In certain embodiments, computer system 102 represents a computer system utilizing clustered computers and components to act as a single pool of seamless resources when accessed through a network. For example, such embodiments may be used in data center, cloud computing, storage area network (SAN), and network attached storage (NAS) applications. In certain embodiments, computer system 102 represents a virtual machine. In general, computer system 102 is representative of any electronic device, or combination of electronic devices, capable of executing machine-readable program instructions, as described in greater detail with regard to FIG. 9.

Computer system 102 includes data management program 104, file system 106, source data 108, clone parent data 110, and clone child data 112. Data management program 104, in conjunction with file system 106, performs various data management operations involving reading, creating, and/or deleting blocks of data in source data 108, clone parent data 110, and/or clone child data 112, as discussed in greater detail later in this specification. The term “block”, as used herein, refers to a finite sequence of bytes (e.g., 16 kilobytes) used by file system 106 to store data. Block sizes can be configured by a user of computer system 102. File system 106 can be implemented with any suitable file system capable of creating and manipulating clone data, in accordance with embodiments of the present invention. For example, file system 106 can be implemented with GPFS™. In some embodiments, data management program 104 can be implemented as a component of file system 106.

Source data 108 comprises blocks of data comprising files stored on computer system 102. For illustrative purposes, discussions of source data 108 may be made with respect to a single source data file; however, it should be understood that source data 108 represents any number of sources data files (e.g., a single file or a plurality of files representing an operating system image).

Clone parent data 110 comprises clone parent blocks. The phrase “clone parent blocks”, as used herein, refers to immutable (i.e., read-only) copies of blocks of source data that, collectively, comprise parent files, which are snapshots of source data files. Again, for illustrative purposes, discussions of clone parent data 110 may be made with respect to a single parent file that is a snapshot of a single source data file of source data 108; however, it should be understood that clone parent data 110 represents any number of parent data files that are cloned copies of source data files.

Clone child data 112 comprises clone child blocks. The phrase “clone child blocks”, as used herein, refers to writable cloned copies of clone parent blocks that, collectively, comprise child files. As discussed in greater detail later in this specification, clone child blocks can include reference pointers to corresponding clone parent blocks, which allow child files to be created quickly and without consuming additional storage space. When writing to a clone child block for the first time (e.g., upon first editing data of the clone child block after having created a child file), data management program 104 can copy data from the referenced clone parent block into a newly allocated block for the clone child block, after which changes to the data of the clone child block can be made. In certain instances, clone child blocks can be pre-allocated and initialized prior to being written to, which can decrease latency and overhead that might otherwise result at the time of first writing to clone child blocks.

Source data 108, clone parent data 110, and child data 112 can be stored using any storage media known in the art. For example, source data 108, clone parent data 110, and clone child data 112 may be stored on one or more Advanced Technology Attachment (ATA), Serial ATA (SATA), Small Computer System Interface (SCSI), or Serial Attached SCSI (SAS) compatible hard disk drives. Similarly, while in this embodiment, source data 108, clone parent data 110, and clone child data 112 are stored locally on computer system 102, in other embodiments, source data 108, clone parent data 110, and/or clone child data 112 can be stored on one or more remote computer systems accessed through a network (e.g., a local area network (LAN), a wide area network (WAN) such as the Internet, and combinations of both).

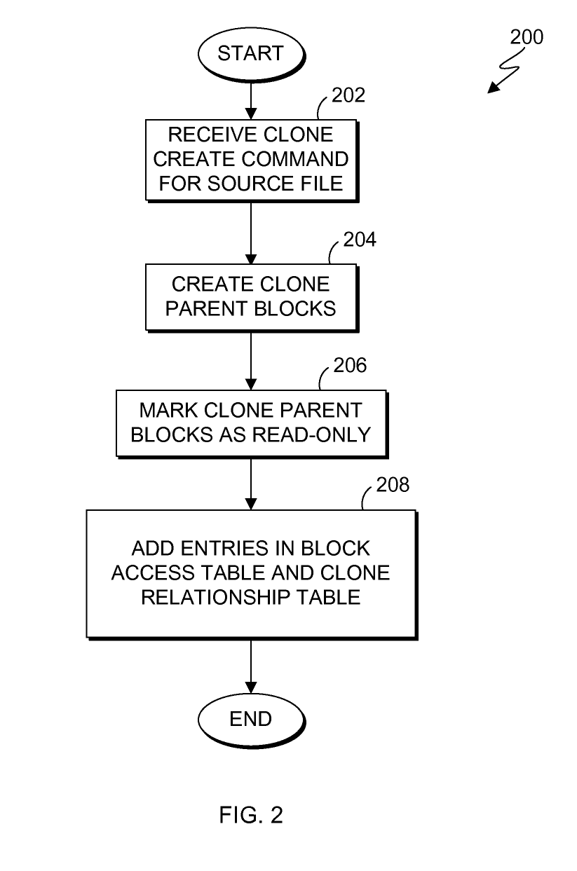

FIG. 2 is a flowchart 200 illustrating operations for creating a clone parent file, in accordance with an embodiment of the present invention. For illustrative purposes, the following discussion is made with respect to creating a single clone parent file from a single source file.

Data management program 104 receives a clone create command for a source file (operation 202). For example, where file system 106 is implemented with GPFS™, data management program 104 receives a clone snap command specifying the source file from which the parent clone file should be created and a name for the parent clone file to be created (e.g., mmclone snap sourceFile1 parentFile1).

Data management program 104 creates clone parent blocks for the source blocks of the source file (operation 204). In this embodiment, each clone parent block contains a copy of the data stored in a corresponding source data block.

Data management program 104 marks the created clone parent blocks as read-only (operation 206). Stated differently, data management program 104 makes the created clone parent blocks immutable, thereby creating a read-only snapshot of the source file at the time at which the clone parent file was created.

Data management program 104 adds entries in a block access table and a clone relationship table (operation 208). In this embodiment, file system 106 maintains a block access table that contains the following information for each block of file system 106: the name of the file to which the data block corresponds; a position number indicating the position of the data block with respect to the other data blocks comprising the file; an assigned block number; and a write access count indicating how many times the data block has been written to. File system 106 creates and maintains entries for source data blocks in the block access table, and data management program 104 creates an entry for each created clone parent block containing the name of the clone parent file (e.g., ParentFile1), along with values for the position number, assigned block number, and write access count that are copied from the entries for the source data block to which the created clone parent block corresponds.

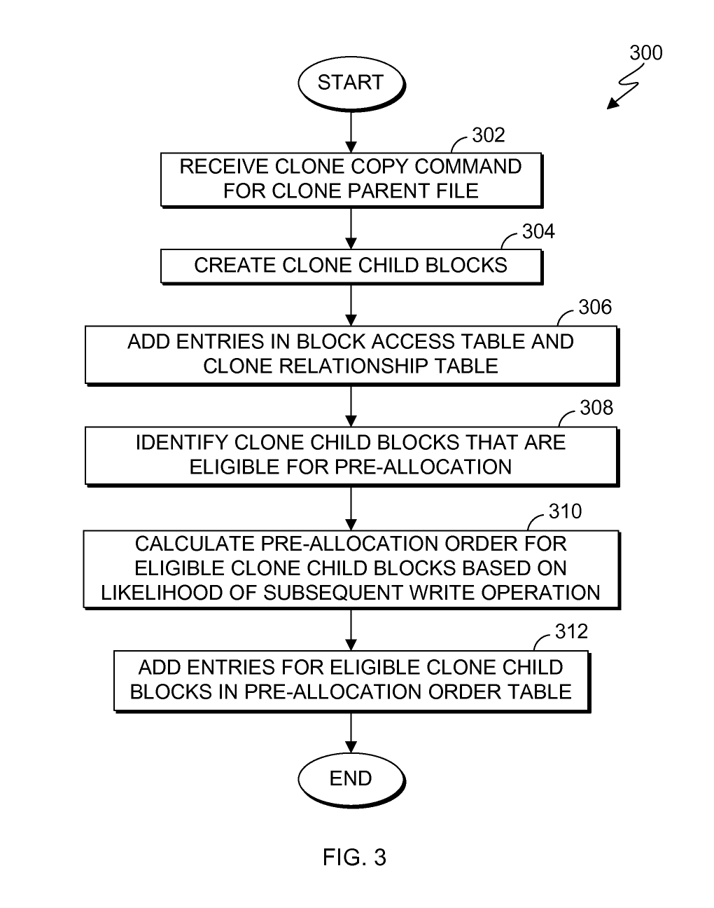

A clone relationship table is also maintained that contains information detailing relationships of source files, parent files, and child files. In this embodiment, data management program 104 creates an entry in the clone relationship table that contains the following information for the created parent file: the name of the parent file (e.g., ParentFile1); the name of the source file to which the parent file corresponds (e.g., sourceFile1); and the names of any child files corresponding to the parent file (e.g., childFile1 and childFile2), as discussed in greater detail with regard to FIG. 3.

FIG. 3 is a flowchart 300 illustrating operations for creating a clone child file, in accordance with an embodiment of the present invention. For illustrative purposes, the following discussion is made with respect to creating a single clone child file from a single clone parent file. The operations of FIG. 3 can be performed to create multiple clone child files of the same clone parent file, and/or multiple clone child files of one or more other clone child files.

Data management program 104 receives a clone copy command for the clone parent file (operation 302). For example, where file system 106 is implemented with GPFS™, data management program 104 receives a clone copy command specifying the clone parent file from which the clone child file should be created, and a name for the clone child file to be created (e.g., mmclone copy parentFile1 childFile1). In other instances, as mentioned above, the clone copy command can specify a clone child file from which to create another clone child file.

Data management program 104 creates clone child blocks for the clone parent blocks of the clone parent file (operation 304). In this embodiment, each clone child block contains a reference pointer to its corresponding clone parent block of the clone parent file. In this manner, the clone child file can be created more quickly and without taking up additional disk space.

Data management program 104 adds entries in the block access table and the clone relationship table (operation 306). In this embodiment, data management program 104 adds entries in the block access table in a similar manner to that discussed with respect to FIG. 2. Here, however, data management program 104 creates an entry for each created clone child block containing the name of the clone child file (e.g., ChildFile1), along with values for the position number, assigned block number, and write access count that are copied from the entries for the clone parent data block to which the created clone child block corresponds. In the clone relationship table, data management program 104 adds the name of the clone child file to the existing entry for the corresponding parent file (e.g., ParentFile1), which also contains a reference to the corresponding source file (e.g., sourceFile1).

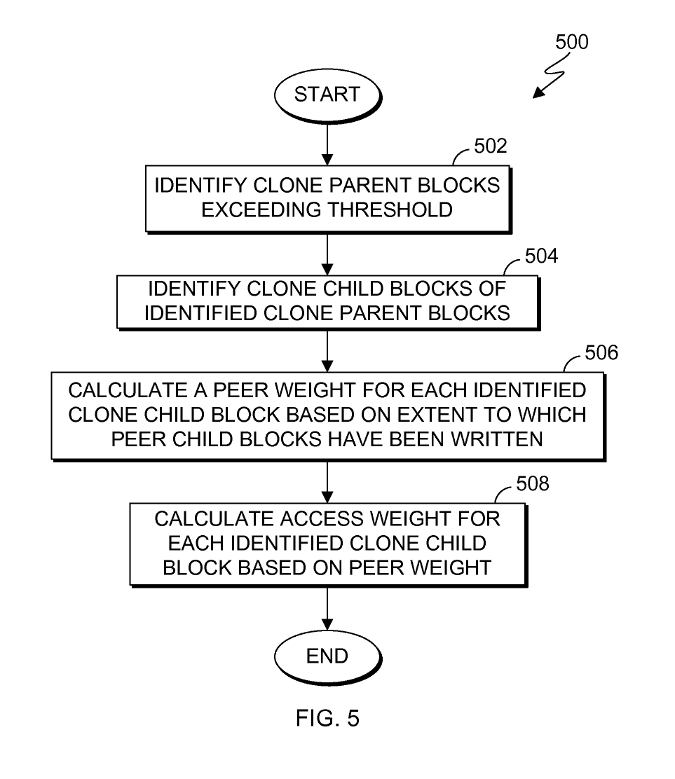

Data management program 104 identifies clone child blocks that are eligible for pre-allocation (operation 308). As previously discussed, certain clone child blocks can be pre-allocated and initialized prior to actually being written to, which can help improve performance. In one embodiment, as discussed in greater detail with regard to FIG. 5, data management program 104 identifies clone child blocks that are eligible for pre-allocation based on whether the corresponding clone parent blocks have write counts that exceed a specified threshold.

Data management program 104 calculates a pre-allocation order for each eligible clone child block identified in operation 308, based on the likelihood of subsequent write operations to each such clone child block (operation 310). In one embodiment, as discussed in greater detail with regard to FIG. 5, data management program 104 calculates pre-allocation orders based on the extent to which peer clone child blocks have been written to, expressed as an access weight.

Data management program 104 adds entries for each eligible clone child block in a pre-allocation order table (operation 312). In this embodiment, the pre-allocation order table contains the following information for each eligible clone child block: the name of the parent file and child file to which the eligible clone child block correspond; a position number indicating the position of the eligible clone child block with respect to the other clone child blocks comprising the clone child file; and an access weight calculated for the eligible clone child block. Eligible clone child blocks can be further sorted by their access weights.

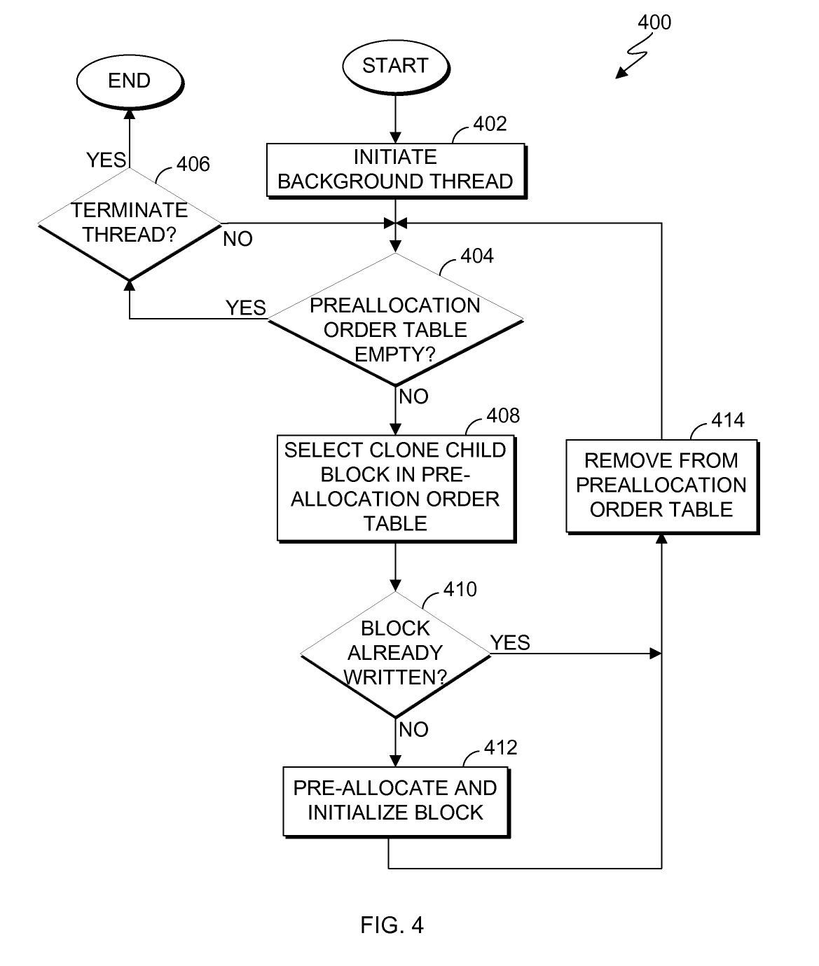

FIG. 4 is a flowchart 400 illustrating operations for pre-allocating and initializing clone child data, in accordance with an embodiment of the present invention.

Data management program 104 initiates a background thread with which the remaining operations of flowchart 400 are performed (operation 402). In this embodiment, the background thread operates in the background of other operations being performed by file system 106, so as to not interfere with input-output performance of file system 106. For example, clone create and clone copy operations can continue to be performed in accordance with the operations of FIGS. 2 and 3, along with read and write operations to source data 108, clone parent data 110, and/or clone child data 112 by various programs.

Data management program 104 accesses the pre-allocation order table and determines whether it is empty (operation 404). If data management program 104 determines that the pre-allocation order table is empty (i.e., it does not contain any entries for clone child blocks) (operation 404; YES branch), then data management program 104 determines whether the background thread should be terminated (operation 406). In this embodiment, data management program 104 can be configured to terminate the background thread after a specified amount of time has elapsed. Similarly, data management program 104 can be configured to terminate the background thread if file system 106 is inactive or computer system 102 is shutdown. If data management program 104 determines that the background thread should be terminated (operation 406; YES branch), then the operations of FIG. 4 end. If data management program 104 determines that the background thread should not be terminated (operation 406; NO branch), then the operations repeat at operation 404.

If data management program 104 determines that the pre-allocation order table is not empty (i.e., it contains at least one entry for a clone child block) (operation 404; NO branch), then data management program 104 selects a clone child block in the pre-allocation order table (operation 408). In this embodiment, data management program 104 selects the clone child block in the pre-allocation order table that has the highest calculated access weight or another measure of priority. In another embodiment, entries in the pre-allocation order table can be sorted according to access weights (highest to lowest) or another measure of priority, and data management program 104 can select the highest entry in the sorted table.

Data management program 104 determines whether the clone child block selected in operation 408 has already been written to (operation 410). In this embodiment, since the operations of FIG. 4 are performed as background operations, the selected clone child block may have already been accessed and written to since the clone child file was created. In that case, data management program 104 and file system 106 would have already allocated a new block, copied the data from the corresponding clone parent block into the allocated block, and written the changed data, as previously discussed. In this embodiment, data management program 104 determines whether the selected clone child block has already been written to by accessing the block access table and comparing the assigned block number for the selected clone child block to the assigned block number for the corresponding clone parent block. A match of these assigned block numbers indicates that the selected clone child block has not been written to; a mismatch of these assigned block numbers indicates that the selected clone child block has been written to.

If data management program 104 determines that the clone child block selected in operation 408 has already been written to (operation 410; YES branch), then data management program 104 removes the entry for the selected clone child block from the pre-allocation order table (operation 414), and the operations repeat back at operation 404.

If data management program 104 determines that the clone child block selected in operation 408 has not already been written to (operation 410; NO branch), then data management program 104 pre-allocates and initializes a new block for the selected clone child block (operation 412). In this embodiment, data management program 104, in conjunction with file system 106, allocates a new free block, copies the data from the corresponding clone parent block into the newly allocated block, and updates the file block access table to reflect a newly assigned block number for the clone child block.

After allocating and initializing a new block for the selected clone child block (operation 412), data management program 104 removes the entry for the selected, pre-allocated and initialized clone child block from the pre-allocation order table (operation 414), as previously discussed.

Accordingly, by performing the operations of FIG. 4, embodiments of the present invention can selectively pre-allocate and initialize clone child blocks to help improve performance by decreasing latency and overhead that might otherwise result at the time of first writing to such clone child blocks. Furthermore, such pre-allocation and initialization can be run as background operations so as not to hinder input-output performance of file system 106.

FIG. 5 is a flowchart 500 illustrating operations for calculating a pre-allocation order, in accordance with another embodiment of the present invention. For example, the operations of flowchart 500 can be performed at operations 308 and 310 of flowchart 300. For illustrative purposes, the following discussion is made with respect to creating a single clone child file from a single clone parent file. The operations of FIG. 5 can be performed to create multiple clone child files of the same clone parent file and/or multiple clone child files of one or more other clone child files.

Data management program 104 accesses the block access table and identifies clone parent blocks having write counts that exceed a specified threshold (operation 502). In this embodiment, a user of computer system 102 can specify a threshold (e.g., 50 writes).

Data management program 104 identifies clone child blocks of the identified clone parent blocks (operation 504). In this embodiment, data management program 104 identifies such clone child blocks by accessing entries for the identified clone parent blocks in the clone relationship table, which lists corresponding clone child blocks of those identified clone parent blocks.

Data management program 104 calculates a peer weight for each clone child block identified in operation 504 based on the extent to which peer child blocks have been written (operation 506). A “peer child block” of a particular identified clone child block refers to any other clone child block that corresponds to (i.e., shares) the same clone parent block as that particular clone child block. In this embodiment, for each clone child block identified in operation 504, data management program 104 first accesses the clone relationship table to find other clone child blocks that correspond to the same clone parent block. Data management program 104 then accesses the block access table and compares the assigned block numbers for the peer child blocks to the assigned block number for the corresponding clone parent block. A match of these assigned block numbers for a peer child block indicates that the peer child block has not been written to; a mismatch of these assigned block numbers indicates that the peer child block has been written to.

Data management program 104 then calculates a peer weight for each clone child block according to the following formula:

$$PeerWeight = \frac{PeerWriteCount}{A} \qquad Formula 1$$

where PeerWriteCount represents a total number of peer child blocks of that clone child block that have been written to, and A represents a factor (e.g., 0.5) that can be configured by a user of computer system 102 to adjust the calculation of peer weights.

Data management program 104 calculates an access weight for each clone child block identified in operation 504 based on its peer weight calculated in operation 506 (operation 508). In this embodiment, data management program 104 calculates an access weight for each clone child block according to the following formula:

AccessWeight=(B*ParentWriteCount)+(C*PeerWeight) Formula 2

where ParentWriteCount represents the write count of the clone parent block to which that clone child block corresponds, PeerWeight is the peer weight value calculated for that clone child block using Formula 1, and B and C are factors that can be configured by a user of computer system 102 to adjust the weighting of ParentWriteCount and PeerWeight, respectively, to adjust the calculation of access weights.

Accordingly, by performing the operations of FIG. 5, access weights can be calculated for clone child blocks that reflect the likelihood that those clone child blocks will be subsequently written to. Clone child blocks having a higher access weights (i.e., clone child blocks having corresponding clone parent blocks and peer blocks that have been written to more frequently) represent clone child blocks that are more likely to be written to. Thus, these clone child blocks can be given higher priority for pre-allocation and initialization, in accordance with the operations of FIG. 4. In other embodiments, other calculations can be used to calculate relative weights or priorities for various clone child blocks based on likelihoods of being written to.

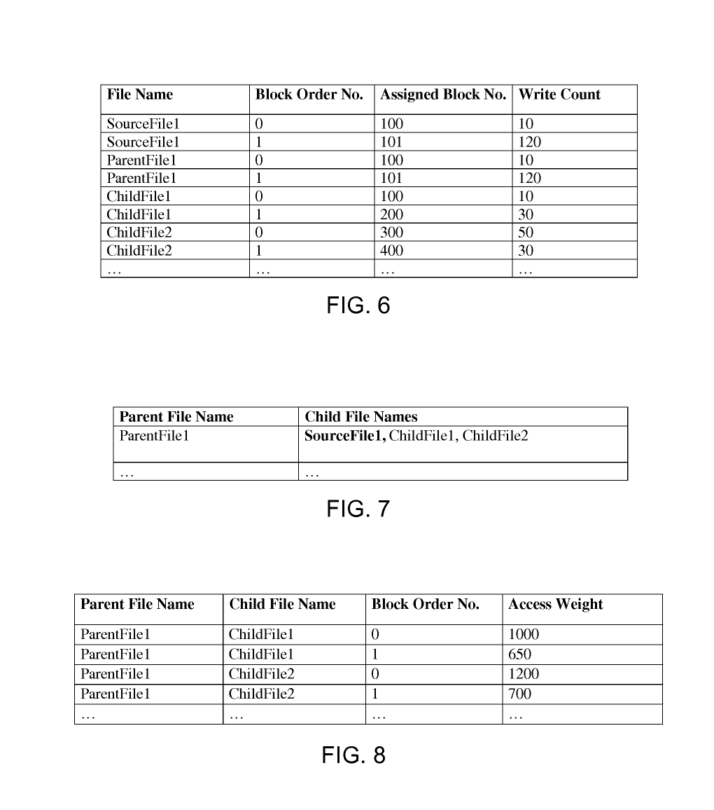

FIG. 6 illustrates an example block access table, in accordance with an embodiment of the present invention. As shown, the block access table contains entries for a plurality of blocks of files on file system 106. For illustrative purposes, each file is shown as comprising two blocks; however, it should be understood that each file can contain any number of blocks depending on the block size used by file system 106 and the size of the file.

Here, SourceFile1 is comprised of two blocks: a first block having block order number 0, assigned block number 100, and a write count of 10 (i.e., 10 writes operations have been performed on this block since its allocation); and a second block having block order number 1, assigned block number 101, and a write count of 120 (i.e., 120 writes operations have been performed on this block since its allocation. ParentFile1 represents a parent file that was created using a clone create operation, as described with respect to FIG. 2. Accordingly, ParentFile1 is comprised of two blocks that are immutable copies of the two blocks of SourceFile1, and the entries in the block access table are identical to those of ParentFile1. ChildFile1 and ChildFile2 represent child files that were created from ParentFile1 using clone copy operations, as described with respect to FIG. 3. In this example, ChildFile1 is comprised of a first block that has not yet been written to and, therefore, has identical entries to those of the corresponding block of ParentFile1: block order number 0, assigned block number 100, and a write count of 10 (i.e., the number of write operations performed on the corresponding parent block). ChildFile1 is also comprised of a second block that has been written to and, therefore, has a new assigned block number and write count, as compared to block order number 1 of ParentFile1: block order number 1, assigned block number 200, and a write count of 30 (i.e., 30 write operations have been performed on this block since ChildFile1 was created). ChildFile2 is comprised of a first block that has been written to and, therefore, has a new assigned block number and write count, as compared to block order number 0 of ParentFile1: block order number 0, assigned block number 300, and a write count of 50 (i.e., 50 write operations have been performed on this block since ChildFile2 was created). ChildFile2 is comprised of a second block that has also been written to and, therefore, has a new assigned block number and write count, as compared to block order number 1 of ParentFile1: block order number 1, assigned block number 400, and a write count of 30 (i.e., 30 write operations have been performed on this block since ChildFile2 was created).

FIG. 7 illustrates an example clone relationship table, in accordance with an embodiment of the present invention. For illustrative purposes, the clone relationship table reflects entries for SourceFile1, ParentFile1, ChildFile1, and ChildFile2 of the block access table; however, it should be understood that the clone relationship table can contain entries for any number of source files, parent files, and child files on file system 106.

As shown, the clone relationship table contains an entry for ParentFile1, along with an entry listing all files that correspond to ParentFile1: SourceFile1 from which ParentFile1 was created (shown in bold to distinguish it); ChildFile1 that is a clone child created from ParentFile1; and ChildFile2 that is also a clone child created from ParentFile1.

FIG. 8 illustrates an example pre-allocation order table, in accordance with an embodiment of the present invention. For illustrative purposes, the pre-allocation order table reflects entries for blocks of ChildFile1 and ChildFile2, which have been determined to be eligible, and for which access weights have been calculated and added to the pre-allocation order table, in accordance with the operations of FIGS. 3 and 5; however, it should be understood that the pre-allocation order table can contain entries for any number of clone child blocks on file system 106 that are eligible for pre-allocation and initialization.

As shown, block order number 0 of ChildFile1 has a calculated access weight of 1000; block order number 1 of ChildFile1 has a calculated access weight of 650; block order number 0 of ChildFile2 has a calculated access weight of 1200; and block order number 1 of ChildFile2 has a calculated access weight of 700. In this embodiment, higher access weights represent higher priority (i.e., earlier position in the pre-allocation order). For example, the blocks listed in the pre-allocation order table can be processed for pre-allocation and initialization in the order of their access weights within each parent file (i.e., block order number 0 of ChildFile1 is processed first, followed by block order number 1 of ChildFile1, followed by block order number 1 of ChildFile2, followed by block order number 0 of ChildFile2). In another example, the blocks listed in the pre-allocation order table can be processed for pre-allocation and initialization based on just their access weights (i.e., block order number 1 of ChildFile2 is processed first, followed by block order number 0 of ChildFile1, followed by block order number 0 of ChildFile2, followed by block order number 1 of ChildFile1).

FIG. 9 is a block diagram of internal and external components of a computer system 900, which is representative the computer systems of FIG. 1, in accordance with an embodiment of the present invention. It should be appreciated that FIG. 9 provides only an illustration of one implementation and does not imply any limitations with regard to the environments in which different embodiments may be implemented. In general, the components illustrated in FIG. 9 are representative of any electronic device capable of executing machine-readable program instructions. Examples of computer systems, environments, and/or configurations that may be represented by the components illustrated in FIG. 9 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 900 includes communications fabric 902, which provides for communications between one or more processors 904, memory 906, persistent storage 908, communications unit 912, and one or more input/output (I/O) interfaces 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media. Software and data is stored in persistent storage 908 for execution and/or access by one or more of the respective processors 904 via one or more memories of memory 906.

Persistent storage 908 may include, for example, a plurality of magnetic hard disk drives. Alternatively, or in addition to magnetic hard disk drives, persistent storage 908 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 908 can also be removable. For example, a removable hard drive can be used for persistent storage 908. Other examples include optical and magnetic disks, thumb drives, and smart cards that are inserted into a drive for transfer onto another computer-readable storage medium that is also part of persistent storage 908.

Communications unit 912 provides for communications with other computer systems or devices via a network. In this exemplary embodiment, communications unit 912 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computer system 102 through communications unit 912 (e.g., via the Internet, a local area network or other wide area network). From communications unit 912, the software and data can be loaded onto persistent storage 908.

One or more I/O interfaces 914 allow for input and output of data with other devices that may be connected to computer system 900. For example, I/O interface 914 can provide a connection to one or more external devices 920 such as a keyboard, computer mouse, touch screen, virtual keyboard, touch pad, pointing device, or other human interface devices. External devices 920 can also include portable computer-readable storage media such as, for example, thumb drives, portable optical or magnetic disks, and memory cards. I/O interface 914 also connects to display 922.

Display 922 provides a mechanism to display data to a user and can be, for example, a computer monitor. Display 922 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing clone data, comprising:
creating, by one or more computer processors, a clone child file from a clone parent file, wherein the clone child file comprises one or more blocks that correspond to one or more respective blocks of the clone parent file;
selecting, by one or more computer processors, one or more blocks of the clone child file based, at least in part, on a likelihood of the selected one or more blocks of the clone child file being subsequently written to;
allocating, by one or more computer processors, storage space for the selected one or more blocks of the clone child file; and
copying, by one or more computer processors, data from one or more blocks of the parent file to which the selected one or more blocks of the clone child file correspond, to the allocated storage space for the selected one or more blocks of the clone child file.

2. The method of claim 1, wherein selecting, by one or more computer processors, one or more blocks of the clone child file based, at least in part, on a likelihood of the selected one or more blocks of the clone child file being subsequently written to comprises:
identifying, by one or more computer processors, one or more blocks of the clone child file that correspond to blocks of the parent having write counts that exceed a specified threshold;
calculating, by one or more computer processors, an order in which to pre-allocate and initialize the identified one or more blocks of the clone child file based, at least in part, on an extent to which peer child blocks of the identified one or more blocks of the clone child file have been written to; and
selecting, by one or more computer processors, the identified one or more blocks of the clone child according to the calculated order.

3. The method of claim 2, wherein calculating, by one or more computer processors, an order in which to pre-allocate and initialize the identified one or more blocks of the clone child file based, at least in part, on an extent to which peer child blocks of the identified one or more blocks of the clone child file have been written to comprises:
calculating, by one or more computer processors, a peer weight for each of the identified one or more blocks of the clone child based; and
calculating, by one or more computer processors, an access weight for each of the identified one or more blocks of the clone child based, at least in part, on the calculated peer weight for each respective identified block of the clone child.

4. The method of claim 3, wherein selecting, by one or more computer processors, the identified one or more blocks of the clone child according to the calculated order comprises:
selecting, by one or more computer processors, the identified one or more blocks of the clone child having highest calculated access weights.

5. The method of claim 1, wherein the clone parent file is a read-only copy of a source file.

6. The method of claim 1, wherein allocating storage space for the selected one or more blocks of the clone child file and copying data to the allocated storage space for the selected one or more blocks of the clone child file are performed as background operations of a file system.

7. A computer program product for managing clone data, comprising:
one or more computer readable storage media and program instructions stored on the one or more computer readable storage media, the program instructions comprising:
program instructions to create a clone child file from a clone parent file, wherein the clone child file comprises one or more blocks that correspond to one or more respective blocks of the clone parent file;
program instructions to select one or more blocks of the clone child file based, at least in part, on a likelihood of the selected one or more blocks of the clone child file being subsequently written to;
program instructions to allocate storage space for the selected one or more blocks of the clone child file; and
program instructions to copy data from one or more blocks of the parent file to which the selected one or more blocks of the clone child file correspond, to the allocated storage space for the selected one or more blocks of the clone child file.

8. The computer program product of claim 7, wherein the program instructions to select one or more blocks of the clone child file based, at least in part, on a likelihood of the selected one or more blocks of the clone child file being subsequently written to, comprise:
program instructions to identify one or more blocks of the clone child file that correspond to blocks of the parent having write counts that exceed a specified threshold;
program instructions to calculate an order in which to pre-allocate and initialize the identified one or more blocks of the clone child file based, at least in part, on an extent to which peer child blocks of the identified one or more blocks of the clone child file have been written to; and
program instructions to select the identified one or more blocks of the clone child according to the calculated order.

9. The computer program product of claim 8, wherein the program instructions to calculate an order in which to pre-allocate and initialize the identified one or more blocks of the clone child file based, at least in part, on an extent to which peer child blocks of the identified one or more blocks of the clone child file have been written to, comprise:
program instructions to calculate a peer weight for each of the identified one or more blocks of the clone child based; and
program instructions to calculate an access weight for each of the identified one or more blocks of the clone child based, at least in part, on the calculated peer weight for each respective identified block of the clone child.

10. The computer program product of claim 9, wherein the program instructions to select the identified one or more blocks of the clone child according to the calculated order comprise:
program instructions to select the identified one or more blocks of the clone child having highest calculated access weights.

11. The computer program product of claim 7, wherein the clone parent file is a read-only copy of a source file.

12. The computer program product of claim 7, wherein the program instructions stored on the one or more computer readable storage media further comprise:
program instructions to create a background thread for allocating storage space for the selected one or more blocks of the clone child file and copying data to the allocated storage space for the selected one or more blocks of the clone child file as background operations of a file system.

13. A computer system for managing clone data, comprising:
one or more computer processors;
one or more computer readable storage media;
program instructions stored on the computer readable storage media for execution by at least one of the one or more processors, the program instructions comprising:
program instructions to create a clone child file from a clone parent file, wherein the clone child file comprises one or more blocks that correspond to one or more respective blocks of the clone parent file;
program instructions to select one or more blocks of the clone child file based, at least in part, on a likelihood of the selected one or more blocks of the clone child file being subsequently written to;
program instructions to allocate storage space for the selected one or more blocks of the clone child file; and
program instructions to copy data from one or more blocks of the parent file to which the selected one or more blocks of the clone child file correspond, to the allocated storage space for the selected one or more blocks of the clone child file.

14. The computer system of claim 13, wherein the program instructions to select one or more blocks of the clone child file based, at least in part, on a likelihood of the selected one or more blocks of the clone child file being subsequently written to comprise:
program instructions to identify one or more blocks of the clone child file that correspond to blocks of the parent having write counts that exceed a specified threshold;
program instructions to calculate an order in which to pre-allocate and initialize the identified one or more blocks of the clone child file based, at least in part, on an extent to which peer child blocks of the identified one or more blocks of the clone child file have been written to; and
program instructions to select the identified one or more blocks of the clone child according to the calculated order.

15. The computer system of claim 14, wherein the program instructions to calculate an order in which to pre-allocate and initialize the identified one or more blocks of the clone child file based, at least in part, on an extent to which peer child blocks of the identified one or more blocks of the clone child file have been written to comprise:
program instructions to calculate a peer weight for each of the identified one or more blocks of the clone child based; and
program instructions to calculate an access weight for each of the identified one or more blocks of the clone child based, at least in part, on the calculated peer weight for each respective identified block of the clone child.

16. The computer system of claim 15, wherein the program instructions to select the identified one or more blocks of the clone child according to the calculated order comprise:
program instructions to, select the identified one or more blocks of the clone child having highest calculated access weights.

17. The computer system of claim 13, wherein the clone parent file is a read-only copy of a source file.

18. The computer system of claim 13, wherein the program instructions stored on the computer readable storage media further comprise:
program instructions to create a background thread for allocating storage space for the selected one or more blocks of the clone child file and copying data to the allocated storage space for the selected one or more blocks of the clone child file as background operations of a file system.
